(19) United States
(12) Patent Application Publication
(10) Pub. No.: US 2017/0237064 A1
(43) Pub. Date: Aug. 17, 2017

(54) ELECTRODE MATERIAL FOR LITHIUM-ION SECONDARY BATTERY, METHOD FOR MANUFACTURING SAME, ELECTRODE FOR LITHIUM-ION SECONDARY BATTERY, AND LITHIUM-ION SECONDARY BATTERY

(71) Applicant: Sumitomo Osaka Cement Co., Ltd, Tokyo (JP)

(72) Inventors: TAKAO KITAGAWA, Tokyo (JP); MASATAKA OYAMA, Tokyo (JP)

(21) Appl. No.: 15/282,068

(22) Filed: Sep. 30, 2016

(30) Foreign Application Priority Data
Feb. 12, 2016 (JP) 2016-025179

(51) Int. Cl. H01M 4/36; H01M 4/134; H01M 4/1397; H01M 4/04; H01M 4/38; H01M 2/16; H01M 4/583; H01M 4/62; H01M 4/66; H01M 10/0525; H01M 10/0569; H01M 10/0568; H01M 4/136; H01M 4/58

(52) U.S. Cl. CPC H01M 4/366; H01M 4/136; H01M 4/134; H01M 4/1397; H01M 4/0404; H01M 4/0471; H01M 4/382; H01M 4/5825; H01M 4/583; H01M 4/623; H01M 4/625; H01M 4/661; H01M 10/0525; H01M 10/0569; H01M 10/0568; H01M 2/1653; H01M 2/162; H01M 2004/028

(57) ABSTRACT

An electrode material for a lithium-ion secondary battery includes an electrode active material and a carbonaceous film with which a surface of the electrode active material is coated, in which a powder resistance under compression at a pressure of 45 MPa is 130 Ω·cm or lower and a lithium-ion secondary battery including a cathode including the electrode material for a lithium-ion secondary battery and an anode made of lithium metal exhibits battery characteristics that a difference between a sum of a charge capacity thereof obtained when constant current charged with an upper limit voltage with respect to the anode set to 4.20 V and a charge capacity thereof obtained when constant voltage charged at 4.20 V for ten days after the constant current charge and a discharge capacity thereof obtained when constant current discharged to 2 V after the constant voltage charge is set to 20 mAh/g or lower.

### CROSS-REFERENCE TO RELATED APPLICATIONS

Priority is claimed based on Japanese Patent Application No. 2016-025179 filed on Feb. 12, 2016, the contents of which are incorporated herein by reference.

### BACKGROUND OF THE INVENTION

Field of the Invention

The present invention relates to an electrode material for a lithium-ion secondary battery, a method for manufacturing the same, an electrode for a lithium-ion secondary battery, and a lithium-ion secondary battery.

Description of Related Art

In recent years, as batteries anticipated to have a small size and a high capacity and weigh less, non-aqueous electrolytic solution-based secondary batteries such as lithium-ion secondary batteries have been proposed and put into practical use. Lithium-ion secondary batteries are constituted of a cathode and an anode which have properties capable of reversibly intercalating and deintercalating lithium ions, and a non-aqueous electrolyte.

As anode active materials for anode materials of lithium-ion secondary batteries, generally, carbon-based materials or Li-containing metal oxides having properties capable of reversibly intercalating and deintercalating lithium ions are used. Examples of the Li-containing metal oxides include lithium titanate (Li₄Ti₅O₁₂).

Meanwhile, as cathode materials of lithium-ion secondary batteries, electrode material mixtures including a cathode active material, a binder, and the like are used. As the cathode active material, for example, a Li-containing metal oxide having properties capable of reversibly intercalating and deintercalating lithium ions such as lithium iron phosphate (LiFePO₄) is used. In addition, cathodes of lithium-ion secondary batteries are formed by applying the electrode material mixture onto the surface of a metal foil that is called a current collector.

These lithium-ion secondary batteries have a smaller size and a higher energy and weigh less than secondary batteries in the related art such as lead batteries, nickel cadmium batteries, and nickel metal hydride batteries. Therefore, lithium-ion secondary batteries are used not only as small-size power supplies used in portable electronic devices such as mobile phones and notebook personal computers but also as large-size stationary emergency power supplies.

In addition, recently, studies have been continued regarding using lithium-ion secondary batteries as high-output power supplies for electrical vehicles, plug-in hybrid vehicles, hybrid vehicles, electric tools, and the like. For these batteries used as high-output power supplies, there is a demand for long service lives and high-speed charging and discharging characteristics.

However, electrode active materials, for example, electrode materials including a lithium phosphate compound having properties capable of reversibly intercalating and deintercalating lithium ions have a problem of poor electron conductivity. Therefore, as a method for increasing the electron conductivity of electrode materials, for example, the following technique is known. The surfaces of the particles of an electrode active material are coated with an organic compound which is a carbon source, and then the organic compound is carbonized. In such a case, a conductive carbonaceous film is formed on the surface of the electrode active material, and it is possible to interpose carbon in the conductive carbonaceous film as an electron-conductive substance. A method for manufacturing an electrode material having increased electron conductivity in the above-described manner has been disclosed (for example, refer to Japanese Laid-open Patent Publication No. 2001-15111).

When the carbonization temperature of this organic compound is too low, the decomposition and reaction of the organic compound does not sufficiently proceed, the organic compound does not sufficiently carbonize, and the decomposition reaction product being generated becomes a high-resistance organic decomposed substance (for example, refer to Japanese Laid-open Patent Publication No. 2013-69566).

On the other hand, when the carbonization temperature of the organic compound is too high, some of lithium iron phosphate which is the electrode active material is reduced by carbon, and it is likely that low-valence iron-based impurities such as pure iron, divalent iron oxides, and iron phosphides are generated. In addition, these low-valence iron-based impurities dissolve in electrolytic solutions and cause the alteration of the electrode active materials of counter electrodes or the generation of gas (for example, refer to Japanese Patent No. 5480544).

### SUMMARY OF THE INVENTION

Even in a small amount that is equal to or less than the measurement limit of X-ray analysis and the like, low-valence iron-based impurities have an influence on the output characteristics and durability or stability of lithium-ion secondary batteries that are used as high-output power supplies for electrical vehicles, plug-in hybrid vehicles, and the like which require long service lives. Therefore, it has been necessary to control impurities in raw materials or impurities being generated during the carbonization of organic compounds.

In the above-described carbonization method, it is common to increase the capacity of calcination casings in order to obtain a larger amount of electrode active material within a unit time. However, when the capacity of the calcination casing is increased, in the calcination of, particularly, a powder material having poor thermal conductivity, temperature unevenness in the powder material inside the calcination casing is increased during thermal treatments. Therefore, even in a case in which the surface portion of the powder material inside the calcination casing is heated to the set temperature of a resistance heating-type electric furnace, the powder material disposed at the central portion in the space inside the calcination casing is not sufficiently heated.

When the set temperature in the furnace is increased in order to make the temperature of the heated powder material disposed at the central portion in the space inside the calcination casing close to the temperature of the surface portion of the powder material inside the calcination casing, it is possible to cause organic compounds even in the powder material disposed at the central portion in the space inside the calcination casing to be sufficiently carbonized.

The surface portion of the powder material inside the calcination casing is not preferred since the electrode active material is heated to higher than the set temperature. Particularly, for lithium iron phosphate and compounds having a similar structure with a different composition among the electrode active materials, in a case in which the electrode active material is excessively heated to higher than the set temperature, the surface portions of the particles of lithium iron phosphate and compounds having a similar structure with a different composition are reduced by carbon, low-valence iron-based impurities such as pure iron, divalent iron oxides, and iron phosphides are generated, and the durability of electrode materials deteriorates.

Meanwhile, when the temperature of the surface portion of the powder material inside the calcination casing is maintained to be equal to or lower than a temperature at which the surface portions of the particles of lithium iron phosphate and compounds having a similar structure with a different composition are reduced by carbon, organic compounds in the powder material disposed at the central portion in the space inside the calcination casing are not sufficiently carbonized, the powder resistance of the heated electrode active material increases, and the input and output characteristics of batteries deteriorate.

As described above, when organic compounds are carbonized using a calcination casing having a large capacity, either durability or output characteristics are sacrificed, and thus there has been a problem that it is difficult to satisfy both characteristics at a high level.

The present invention has been made in consideration of the above-described circumstances, and an object of the present invention is to provide an electrode material for a lithium-ion secondary battery having high output characteristics and high durability provided by decreasing the temperature unevenness in a calcination casing that is used in the calcination of a mixture of an organic compound which serves as a raw material of a carbonaceous film and an electrode active material, a method for manufacturing the same, an electrode for a lithium-ion secondary battery formed using the electrode material for a lithium-ion secondary battery, and a lithium-ion secondary battery including the electrode for a lithium-ion secondary battery.

As a result of intensive studies, the present inventors and the like found that, in an electrode material for a lithium-ion secondary battery including an electrode active material and a carbonaceous film with which the surface of the electrode active material is coated, when the powder resistance under compression at a pressure of 45 MPa is 130 Ω·cm or lower and the difference between the sum of the charge capacity of a lithium-ion secondary battery including a cathode including the electrode material for a lithium-ion secondary battery and an anode made of lithium metal obtained when constant current charged with the upper limit voltage with respect to the anode set to 4.20 V and the charge capacity of the lithium-ion secondary battery obtained when constant voltage charged at 4.20 V for ten days after the constant current charge and the discharge capacity of the lithium-ion secondary battery obtained when constant current discharged to 2 V after the constant voltage charge is set to 20 mAh/g or lower, it is possible to a small amount of control low-valence iron-based impurities which is equal to or less than the measurement limit of X-ray analysis and the like and obtain an electrode material for a lithium-ion secondary battery having excellent output characteristics and excellent durability or stability and completed the present invention.

An electrode material for a lithium-ion secondary battery of the present invention includes an electrode active material and a carbonaceous film with which a surface of the electrode active material is coated, in which a powder resistance under compression at a pressure of 45 MPa is 130 Ω·cm or lower and battery characteristics that a difference between a sum of a charge capacity of a lithium-ion secondary battery including a cathode including the electrode material for a lithium-ion secondary battery and an anode made of lithium metal obtained when constant current charged with an upper limit voltage with respect to the anode set to 4.20 V and a charge capacity of the lithium-ion secondary battery obtained when constant voltage charged at 4.20 V for ten days after the constant current charge and a discharge capacity of the lithium-ion secondary battery obtained when constant current discharged to 2 V after the constant voltage charge is set to 20 mAh/g or lower are exhibited.

An electrode for a lithium-ion secondary battery of the present invention includes the electrode material for a lithium-ion secondary battery of the present invention.

A lithium-ion secondary battery of the present invention includes a cathode; an anode; and a non-aqueous electrolyte, in which the cathode is the electrode for a lithium-ion secondary battery of the present invention.

A method for manufacturing an electrode material for a lithium-ion secondary battery of the present invention includes an electrode active material and a carbonaceous film with which a surface of the electrode active material is coated, including a slurry preparation step of preparing a slurry by mixing at least one electrode active material particle raw material selected from the group consisting of the electrode active material and precursors of the electrode active material, an organic compound which is a precursor of the carbonaceous film, and a solvent together; and a calcination step of drying the slurry and calcinating the obtained dried substance in a non-oxidative atmosphere by means of both resistance heating and electromagnetic wave heating.

According to the present invention, it is possible to provide an electrode material for a lithium-ion secondary battery having high output characteristics and high durability, a method for manufacturing the same, an electrode for a lithium-ion secondary battery including the electrode material for a lithium-ion secondary battery, and a lithium-ion secondary battery including the electrode for a lithium-ion secondary battery.

### DETAILED DESCRIPTION OF THE INVENTION

Embodiments of an electrode material for a lithium-ion secondary battery, a method for manufacturing the same, an electrode for a lithium-ion secondary battery, and a lithium-ion secondary battery of the present invention will be described.

Meanwhile, the present embodiment is specific description for better understanding of the gist of the invention and does not limit the present invention unless particularly otherwise described.

Electrode Material for Lithium-Ion Secondary Battery

An electrode material for a lithium-ion secondary battery of the present embodiment is an electrode material for a lithium-ion secondary battery including an electrode active material and a carbonaceous film with which a surface of the electrode active material is coated, in which a powder resistance under compression at a pressure of 45 MPa is 130 Ω·cm or lower and battery characteristics that a difference between a sum of a charge capacity of a lithium-ion secondary battery including a cathode including the electrode material for a lithium-ion secondary battery and an anode made of lithium metal obtained when constant current charged with an upper limit voltage with respect to the anode set to 4.20 V and a charge capacity of the lithium-ion secondary battery obtained when constant voltage charged at 4.20 V for ten days after the constant current charge and a discharge capacity of the lithium-ion secondary battery obtained when constant current discharged to 2 V after the constant voltage charge is set to 20 mAh/g or lower are exhibited.

The average primary particle diameter of the electrode material for a lithium-ion secondary battery of the present embodiment (primary particles in which the surface of the electrode active material is coated with the carbonaceous film) is preferably 0.01 μm or more and 5 μm or less and more preferably 0.02 μm or more and 1 μm or less.

When the average primary particle diameter of the electrode material for a lithium-ion secondary battery is 0.01 μm or more, the specific surface area of the electrode material for a lithium-ion secondary battery increases, whereby it is possible to suppress an increase in the mass of necessary carbon and suppress a decrease in the charge and discharge capacity of lithium-ion secondary batteries. On the other hand, when the average primary particle diameter of the electrode material for a lithium-ion secondary battery is 5 μm or less, it is possible to suppress an increase in time taken for lithium ions or electrons to migrate in the electrode material for a lithium-ion secondary battery. Therefore, it is possible to suppress output characteristics being deteriorated due to an increase in the internal resistance of lithium-ion secondary batteries.

Here, the average particle diameter refers to the volume-average particle diameter. The average primary particle diameter of the electrode material for a lithium-ion secondary battery can be measured using a laser diffraction and scattering particle size distribution measurement instrument or the like. In addition, it is also possible to arbitrarily select multiple primary particles observed using a scanning electron microscope (SEM) and compute the average particle diameter of the primary particles.

The powder resistance of the electrode material for a lithium-ion secondary battery of the present embodiment is 130 Ω·cm or lower, preferably 90 Ω·cm or lower, and more preferably 30 Ω·cm or lower. The lower limit value of the powder resistance is not particularly limited, but is, for example, 0.01 Ω·cm.

The powder resistance of the electrode material for a lithium-ion secondary battery of the present embodiment is a value measured by means of four-point measurement in which four probes are brought into contact with the surface of a compact formed by injecting the electrode material into a mold and compressing the electrode material at a pressure of 45 MPa.

When the powder resistance under compression at a pressure of 45 MPa is set to 130 Ω·cm or lower, it is possible to obtain electrode materials for a lithium-ion secondary battery which do not include high-resistance decomposed substances and reaction products which are generated in a case in which an organic compound which is a raw material of the carbonaceous film is not sufficiently carbonized and has high output characteristics.

The amount of carbon in the electrode material for a lithium-ion secondary battery of the present embodiment is preferably 0.1% by mass or more and 10% by mass or less and more preferably 0.3% by mass or more and 3% by mass or less.

When the amount of carbon is 0.1% by mass or more, the discharge capacity of lithium-ion secondary batteries at a high charge-discharge rate increases, and it is possible to realize sufficient charge and discharge rate performance. On the other hand, when the amount of carbon is 10% by mass or less, it is possible to suppress the battery capacity of lithium-ion secondary batteries per unit mass of the electrode material for a lithium-ion secondary battery being decreased more than necessary without an excess increase in the amount of carbon inactive with respect to electrochemical reactions.

The specific surface area of the electrode material for a lithium-ion secondary battery of the present embodiment is preferably 1 m²/g or more and 20 m²/g or less.

When the specific surface area is 1 m²/g or more, the average migration distance of lithium ions in solid phases in the electrode material for a lithium-ion secondary battery becomes short, and it is possible to realize sufficient charge and discharge rate performance. On the other hand, when the specific surface area is 20 m²/g or less, it is possible to suppress the amount of carbon necessary to coat the surface of the electrode active material being excessively increased, and thus it is possible to suppress a decrease in the battery capacity of lithium-ion secondary batteries per unit mass of the electrode material for a lithium-ion secondary battery without excessively increasing the amount of carbon inactive with respect to electrochemical reactions.

The electrode material for a lithium-ion secondary battery of the present embodiment exhibits battery characteristics that the difference (hereinafter, this difference will be referred to as “trickle test irreversible capacity”) between the sum (C) of the charge capacity (A) of a lithium-ion secondary battery including a cathode including the electrode material for a lithium-ion secondary battery of the present embodiment and an anode made of lithium metal obtained when constant current charged with the upper limit voltage with respect to the anode set to 4.20 V and the charge capacity (B) of the lithium-ion secondary battery obtained when constant voltage charged at 4.20 V for ten days after the constant current charge and the discharge capacity (D) of the lithium-ion secondary battery obtained when constant current discharged to 2 V after the constant voltage charge is 20 mAh/g or lower, preferably exhibits battery characteristics that the difference is 15 mAh/g or lower, and more preferably exhibits battery characteristics that the difference is 13 mAh/g or lower.

Meanwhile, the trickle test irreversible capacity refers to the difference between the sum (C) of the constant current charge capacity (A) and the constant voltage charge capacity (B) and the constant current discharge capacity (D).

In the electrode material for a lithium-ion secondary battery of the present embodiment, the trickle test irreversible capacity indicates the correlation with the abundance of low-valence iron-based impurities such as pure iron, divalent iron oxides, and iron phosphides. Therefore, when the trickle test irreversible capacity is 20 mAh/g or lower, in a case in which a cathode including the electrode material for a lithium-ion secondary battery is applied to lithium-ion secondary batteries, it is possible to decrease the elution amount of iron derived from low-valence iron-based impurities into non-aqueous electrolytes. That is, it is possible to obtain highly durable electrode materials for a lithium-ion secondary battery.

In a case in which a voltage of 4.20 V is applied to lithium, low-valence iron-based impurities reach the theoretical oxidization and decomposition potential and are thus oxidized and decomposed. When low-valence iron-based impurities are oxidized and decomposed, dissolved iron ions are precipitated on the anode, solid electrolyte interface (SEI) coats on the anode break, lithium is deactivated due to an increase in the reaction resistance or the re-precipitation of the SEI coats. Therefore, the content of low-valence iron-based impurities in the electrode material for a lithium-ion secondary battery of the present embodiment is preferably as low as possible. Since oxidization and decomposition becomes an irreversible charge capacity and is represented by the charge and discharge capacity, a decrease in the trickle test irreversible capacity is the same as a decrease in low-valence iron-based impurities.

The reason for setting the upper limit voltage during constant current charge to 4.20 V is that trivalent or higher iron compounds are not oxidized and decomposed at 4.20 V. That is, it is possible to compute the abundance of divalent or lower low-valence iron-based impurities, from which iron is easily eluted, alone among iron-based impurities.

Electrode Active Material

The electrode active material in the present embodiment is particles including one selected from the group consisting of lithium cobalt oxide, lithium nickel oxide, lithium manganese oxide, lithium titanium oxide, and compounds represented by LiₓA_{y}D_{z}PO₄ (here, A represents at least one selected from the group consisting of Co, Mn, Ni, Fe, Cu, and Cr, D represents at least one selected from the group consisting of Mg, Ca, Sr, Ba, Ti, Zn, B, Al, Ga, In, Si, Ge, Sc, Y, and rare earth elements, 0≦x<2, 0<y<1.5, and 0≦z<1.5).

Meanwhile, the rare earth elements refer to 15 elements of La, Ce, Pr, Nd, Pm, Sm, Eu, Gd, Tb, Dy, Ho, Er, Tm, Yb, and Lu which belong to the lanthanum series.

The average primary particle diameter of the primary particles of the electrode active material in the present embodiment is preferably 0.01 μm or more and 5 μm or less and more preferably 0.02 μm or more and 1 μm or less.

When the average primary particle diameter of the primary particles of the electrode active material is 0.01 μm or more, it is possible to sufficiently coat the surfaces of the primary particles of the electrode active material with the carbonaceous film. In addition, it is possible to increase the discharge capacity of the lithium-ion secondary battery during high-speed charge and discharge and realize sufficient charge and discharge performance. On the other hand, when the average primary particle diameter of the primary particles of the electrode active material is 5 μm or less, it is possible to decrease the internal resistance of the primary particles of the electrode active material. In addition, it is possible to increase the discharge capacity of the lithium-ion secondary battery during high-speed charge and discharge.

The shape of the primary particles of the electrode active material in the present embodiment is not particularly limited. However, the shape of the primary particles of the electrode active material is preferably a spherical shape since it is easy to generate electrode materials made of spherical, particularly, truly spherical secondary particles.

Another reason for the shape of the primary particles of the electrode active material being preferably a spherical shape is that it is possible to decrease the amount of a solvent when electrode material paste is prepared by mixing the electrode material for a lithium-ion secondary battery, a binder resin (binding agent), and a solvent. In addition, still another reason for the shape of the primary particles of the electrode active material being preferably a spherical shape is that it becomes easy to apply the electrode material paste to current collectors. Furthermore, when the shape of the primary particles of the electrode active material is a spherical shape, the surface area of the primary particles of the electrode active material is minimized, and thus it is possible to minimize the amount of the binder resin (binding agent) blended into the electrode material paste. As a result, it is possible to decrease the internal resistance of electrodes for which the electrode material for a lithium-ion secondary battery of the present embodiment is used. In addition, when the shape of the primary particles of the electrode active material is a spherical shape, it becomes easy to closely pack the electrode material for a lithium-ion secondary battery, and thus the amount of the electrode material for a lithium-ion secondary battery packed per unit volume of the electrode increases. As a result, it is possible to increase the electrode density, and high-capacity lithium-ion secondary batteries can be obtained.

Carbonaceous Film

The carbonaceous film coats the surface of the electrode active material and improves the electron conductivity of the electrode material for a lithium-ion secondary battery.

The thickness of the carbonaceous film is preferably 0.2 nm or more and 10 nm or less and more preferably 0.5 nm or more and 4 nm or less.

When the thickness of the carbonaceous film is 0.2 nm or more, it is possible to prevent the excessively thin thickness of the carbonaceous film from disabling the formation of films having a desired resistance value. In addition, it is possible to ensure conductive properties suitable for the electrode material for a lithium-ion secondary battery. On the other hand, when the thickness of the carbonaceous film is 10 nm or less, it is possible to suppress a decrease in the battery capacity per unit mass of the electrode material for a lithium-ion secondary battery.

In addition, when the thickness of the carbonaceous film is in the above-described range, it becomes easy to closely pack the electrode material for a lithium-ion secondary battery, and thus the amount of the electrode material for a lithium-ion secondary battery packed per unit volume of the electrode increases. As a result, it is possible to increase the electrode density, and high-capacity lithium-ion secondary batteries can be obtained.

According to the electrode material for a lithium-ion secondary battery of the present embodiment, since the powder resistance under compression at a pressure of 45 MPa is 130 Ω·cm or lower, and battery characteristics that the trickle test irreversible capacity is 20 mAh/g or lower, it is possible to provide lithium-ion secondary batteries having high output characteristics and high durability.

Method for Manufacturing Electrode Material for Lithium-Ion Secondary Battery

A method for manufacturing an electrode material for a lithium-ion secondary battery of the present embodiment includes a slurry preparation step of preparing a slurry by mixing at least one electrode active material particle raw material selected from the group consisting of the electrode active material and precursors of the electrode active material, an organic compound which is a precursor of the carbonaceous film, and water together and a calcination step of drying the slurry and calcinating the obtained dried substance in a non-oxidative atmosphere.

Step of Manufacturing Electrode Active Material and Precursor of Electrode Active Material

As a method for manufacturing the compounds represented by LiₓA_{y}D_{z}PO₄, it is possible to use a method in the related art such as a solid-phase synthesis method, a hydrothermal synthesis method, a sol-gel synthesis method, a gas-phase synthesis method, or a molten salt synthesis method. Examples of LiₓA_{y}D_{z}PO₄ obtained using the above-described method include particulate LiₓA_{y}D_{z}PO₄ (hereinafter, in some cases, referred to as “LiₓA_{y}D_{z}PO₄ particles”).

LiₓA_{y}D_{z}PO₄ particles can be obtained by, for example, hydrothermally synthesizing a slurry-form mixture obtained by mixing a D source, a P source, water, and, if necessary, a Li source and an A source. According to the hydrothermal synthesis, LiₓA_{y}D_{z}PO₄ is generated in water in a precipitate form. The obtained precipitate may be a precursor of LiₓA_{y}D_{z}PO₄. In this case, target LiₓA_{y}D_{z}PO₄ particles can be obtained by calcinating the precursor of LiₓA_{y}D_{z}PO₄.

In the hydrothermal synthesis, a pressure-resistant airtight container is preferably used.

Here, examples of the Li source include lithium salts such as lithium acetate (LiCH₃COO) and lithiumchloride (LiCl), lithium hydroxide (LiOH), and the like. Among these, as the Li source, at least one selected from the group consisting of lithium acetate, lithium chloride, and lithium hydroxide is preferably used.

Examples of the A source include chlorides, carboxylates, sulfates, and the like which include at least one selected from the group consisting of Co, Mn, Ni, Fe, Cu, and Cr. For example, in a case in which A in LiₓA_{y}D_{z}PO₄ is Fe, examples of a Fe source include divalent iron salts such as iron (II) chloride (FeCl₂), iron (II) acetate (Fe(CH₃COO)₂), and iron (II) sulfate (FeSO₄). Among these, as the Fe source, at least one selected from the group consisting of iron (II) chloride, iron (II) acetate, and iron (II) sulfate is preferably used.

Examples of the D source include chlorides, carboxylates, sulfates, and the like which include at least one selected from the group consisting of Mg, Ca, Sr, Ba, Ti, Zn, B, Al, Ga, In, Si, Ge, Sc, Y, and rare earth elements.

Examples of the P source include phosphoric acid compounds such as phosphoric acid (H₃PO₄), ammonium dihydrogen phosphate (NH₄H₂PO₄), and diammonium phosphate ((NH₄)₂HPO₄). Among these, as the P source, at least one selected from the group consisting of phosphoric acid, ammonium dihydrogen phosphate, and diammonium hydrogen phosphate is preferably used.

Slurry Preparation Step

In the slurry preparation step, since the organic compound which is a raw material of the carbonaceous film is interposed between the electrode active materials or the precursors of the electrode active material and the components are uniformly mixed together, the surfaces of the electrode active material or the precursor of the electrode active material can be evenly coated with the organic compound.

Furthermore, in the calcination step, the organic compound with which the surfaces of the electrode active material or the precursor of the electrode active material are coated carbonizes, thereby obtaining the electrode material for a lithium-ion secondary battery including the electrode active material uniformly coated with the carbonaceous film.

The amount of the organic compound blended into the electrode active material or the precursor of the electrode active material is preferably 0.20 parts by mass or more and 20.0 parts by mass or less and more preferably 0.6 parts by mass or more and 6.0 parts by mass or less with respect to 100 parts by mass of the electrode active material or the precursor of the electrode active material when the total mass of the organic compound is converted in terms of a carbon element.

When the carbon element-equivalent amount of the organic component blended is 0.20 parts by mass or more, it is possible to set the coating ratio of the surface of the electrode active material with the carbonaceous film that is generated by thermally treating the organic compound to 80% or more. Therefore, the discharge capacity of lithium-ion secondary batteries at a high charge-discharge rate increases, and sufficient charge and discharge rate performance can be realized. On the other hand, when the carbon element-equivalent amount of the organic component blended is 20.0 parts by mass or less, the amount of the electrode active material blended does not relatively decrease, and the capacity of lithium-ion secondary batteries does not decrease. In addition, when the carbon element-equivalent amount of the organic component blended is 20.0 parts by mass or less, the electrode active material does not excessively support the carbonaceous film, and the bulk density of the electrode active material does not decrease.

Meanwhile, when the bulk density of the electrode active material supporting the carbonaceous film decreases, the electrode density in electrodes including the electrode material for a lithium-ion secondary battery including the electrode active material decreases, and the battery capacity of the lithium-ion secondary battery per unit volume decreases.

The organic compound that is used in the method for manufacturing the electrode material for a lithium-ion secondary battery of the present embodiment is not particularly limited as long as the compound is capable of forming the carbonaceous film on the surface of the electrode active material. The above-described organic compound is, for example, at least one compound selected from the group consisting of polyvinyl alcohol (PVA), polyvinyl pyrrolidone, cellulose, starch, gelatin, carboxymethyl cellulose, methyl cellulose, hydroxymethyl cellulose, hydroxyethyl cellulose, polyacrylic acid, polystyrene sulfonate, polyacrylamide, polyvinyl acetate, glucose, fructose, galactose, mannose, maltose, sucrose, lactose, glycogen, pectin, alginic acid, glucomannan, chitin, hyaluronic acid, chondroitin, agarose, polyethers, divalent alcohols, and the like.

Examples of the divalent alcohols include polyethylene glycol, propylene glycol, polyglycerin, glycerin, and the like.

The electrode active material which is coated with the organic compound or the precursor of the electrode active material, that is, the electrode active material or the precursor of the electrode active material which includes the organic compound contains moisture. In a case in which the above-described electrode active material or the precursor of the electrode active material which includes the organic compound is heated at 100° C. to 200° C. for 0.5 hours to 1.0 hour, the loss on heating measured using a halogen moisture meter is preferably 0.1% by mass or more and less than 10% by mass and more preferably 0.5% by mass or more and 8% by mass or less.

When the loss on heating is 0.1% by mass or more, when the dried substance of the slurry is calcinated in the calcination step described below, it is possible to sufficiently heat the organic compound by means of heating using electromagnetic waves and exhibit the effect of joint use of resistance heating and electromagnetic wave heating. On the other hand, when the loss on heating is less than 10% by mass, in the calcination step described below, it is possible to prevent the dried substance of the slurry from being excessively heated and altered.

In the slurry preparation step, the electrode active material or the precursor of the electrode active material and the organic compound are dissolved or dispersed in a solvent, thereby preparing a homogeneous slurry.

When these raw materials are dissolved or dispersed in a solvent, it is also possible to add a dispersant thereto.

A method for dissolving or dispersing the electrode active material or the precursor of the electrode active material and the organic compound in a solvent is not particularly limited as long as the electrode active material or the precursor of the electrode active material is dispersed in a solvent, and the organic compound are dissolved or dispersed in the solvent. The above-described method is preferably a method in which a medium stirring-type dispersing apparatus that stirs medium particles at a high speed such as a planetary ball mill, an oscillation ball mill, a bead mill, a paint shaker, or an attritor is used.

Examples of the solvent include water, alcohols such as methanol, ethanol, 1-propanol, 2-propanol (isopropyl alcohol: IPA), butanol, pentanol, hexanol, octanol, and diacetone alcohol, esters such as ethyl acetate, butyl acetate, ethyl lactate, propylene glycol monomethyl ether acetate, propylene glycol monoethyl ether acetate, and γ-butyrolactone, ethers such as diethyl ether, ethylene glycol monomethyl ether (methyl cellosolve), ethylene glycol monoethyl ether (ethyl cellosolve), ethylene glycol monobutyl ether (butyl cellosolve), diethylene glycol monomethyl ether, and diethylene glycol monoethyl ether, ketones such as acetone, methyl ethyl ketone (MEK), methyl isobutyl ketone (MIBK), acetylacetone, and cyclohexanone, amides such as dimethyl formamide, N,N-dimethylacetoacetamide, and N-methyl-2-pyrrolidone (NMP), glycols such as ethylene glycol, diethylene glycol, and propylene glycol, and the like. These solvents may be used singly, or a mixture of two or more solvents may be used.

In addition, in the method for manufacturing the electrode material for a lithium-ion secondary battery of the present embodiment, a mixture of the electrode active material or the precursor of the electrode active material and the organic compound may be prepared by drying the slurry formed by dispersing the electrode active material or the precursor of the electrode active material and the organic compound in the solvent.

In addition, a granulated body of the mixture of the electrode active material or the precursor of the electrode active material and the organic compound may be generated by spraying and drying the above-described slurry in a high-temperature atmosphere, for example, in the atmosphere at 110° C. or higher and 200° C. or lower using a spraying and thermal decomposition method. In this spraying and thermal decomposition method, the particle diameters of liquid droplets during spraying are preferably 0.01 μm or more and 100 μm or less in order to generate a substantially spherical granulated body by rapidly drying the slurry.

Calcination Step

Next, the slurry prepared in the slurry preparation step is sprayed and dried in a high-temperature atmosphere, for example, in the atmosphere of 70° C. or higher and 250° C. or lower.

Next, the obtained dried substance is calcinated in a non-oxidative atmosphere jointly using resistance heating and electromagnetic wave heating.

In the calcination step in the method for manufacturing the electrode material for a lithium-ion secondary battery of the present embodiment, the dried substance of the slurry is put into a calcination casing and is calcinated.

As the calcination casing, a casing made of a substance having excellent thermal conductivity is used, and, for example, a carbon casing, a casing made of an oxide ceramic such as zirconia, alumina, titania, or silica, a casing made of a carbide ceramic such as silicon carbide, tungsten carbide, or hafnium carbide, a casing made of a high-melting-point metal such as iridium, gold, platinum, nickel, copper, or hafnium, or the like is used. Among these, a carbon casing is preferred.

In the present embodiment, resistance heating and electromagnetic wave heating are jointly used, in more detail, a resistance heating-type electric furnace and an electromagnetic wave-generating device for electromagnetic wave heating are jointly used, whereby the temperature unevenness inside the calcination casing can be decreased more than a case in which only resistance heating is performed when the dried substance of the slurry is calcinated. Electromagnetic wave heating enables selective heating of the organic compound in the dried substance of the slurry. Therefore, the organic compound can be efficiently carbonized.

The electromagnetic wave-generating device for electromagnetic wave heating is installed in a place maintained at almost the same temperature as the set temperature of an electric furnace called a soaking area of resistance heating-type electric furnaces. In addition, the electromagnetic wave-generating device for electromagnetic wave heating can be installed in all places near a heater in a continuous calcination furnace such as a roller hearth kiln.

Meanwhile, resistance heating and electromagnetic wave heating are preferably jointly used in the entire temperature range in which the properties of the electrode material for a lithium-ion secondary battery to be obtained are varied due to the temperature unevenness. The temperature range in which the properties of the electrode material for a lithium-ion secondary battery are varied due to the temperature unevenness is, for example, a temperature range immediately after the set temperature reaches the peak holding temperature or a temperature range of a process in which the carbonization reaction of the organic compound progresses.

Examples of the resistance heating-type electric furnace include a roller hearth kiln, a tubular furnace, and the like.

In thermal treatments using the above-described device, the dried substance of the slurry is injected into a calcination casing made of the above-described substance having excellent thermal conductivity, the calcination casing storing the dried substance of the slurry is disposed in the furnace, and the calcination casing is heated so as to carbonize the organic compound, thereby obtaining an electrode active material coated with the carbonaceous film.

In electromagnetic wave heating, electromagnetic waves having a wavelength of 1 mm or longer and 100 km or shorter are preferably used, and electromagnetic waves having a wavelength of 1 mm or longer and 1 m or shorter are more preferably used.

When electromagnetic waves having a wavelength of 1 mm or longer are used, it is possible to sufficiently heat not only limited portions near the surface of an article to be heated (the dried substance of the slurry) but also the central portion (inside) of the article to be heated with the electromagnetic waves. On the other hand, when electromagnetic waves having a wavelength of 100 km or shorter are used, the electromagnetic waves do not become ultra-long wavelengths, and it is possible to sufficiently heat the central portion (inside) of the article to be heated.

In the calcination step, the calcination temperature of the dried substance of the slurry is preferably 630° C. or higher and 800° C. or lower and more preferably 680° C. or higher and 790° C. or lower.

When the calcination temperature is 630° C. or higher, the decomposition and carbonization reaction of the organic compound sufficiently proceeds, and low-resistance decomposed substance of organic substances can be generated. On the other hand, when the calcination temperature is 800° C. or lower, there are no cases in which a part of the electrode active material or the precursor of the electrode active material in the dried substance of the slurry is reduced by carbon, and low-valence iron-based impurities such as pure ion, iron oxides, and iron phosphides are not generated either.

In the calcination step, the calcination duration of the dried substance of the slurry is not particularly limited as long as the organic compound is sufficiently carbonized, but is, for example, preferably 0.01 hours or longer and 20 hours or shorter.

In the calcination step, the non-oxidative atmosphere is preferably an inert atmosphere filled with an inert gas such as nitrogen (N₂) or argon (Ar) or a reducing atmosphere including a reducing gas such as hydrogen (H₂) or carbon monoxide (CO).

In a case in which it is necessary to further suppress the dried substance of the slurry being oxidized, the non-oxidative atmosphere is more preferably a reducing atmosphere.

According to the method for manufacturing the electrode material for a lithium-ion secondary battery of the present embodiment, since resistance heating and electromagnetic wave heating are jointly used in the calcination step, the decomposition and carbonization reaction of the organic compound sufficiently progresses and carbon is generated. In addition, the carbon is attached to the surfaces of the electrode active material particles and turns into the carbonaceous film. Therefore, the surface of the electrode active material is coated with the carbonaceous film. That is, according to the method for manufacturing the electrode material for a lithium-ion secondary battery of the present embodiment, it is possible to provide lithium-ion secondary batteries having high output characteristics and high durability.

Here, as the calcination duration increases, there are cases in which lithium in the electrode active material diffuses into the carbonaceous film, a state in which lithium is present in the carbonaceous film is formed, and the conductivity of the carbonaceous film further improves.

However, when the calcination duration becomes too long, there are cases in which abnormal gain growth occurs or electrode active materials partially deficient in lithium are generated, and thus the characteristics of the electrode material become poor. In addition, when the above-described electrode material is used, the characteristics of lithium-ion secondary batteries degrade.

Electrode for Lithium-Ion Secondary Battery

An electrode for a lithium-ion secondary battery of the present embodiment (hereinafter, in some cases, referred to as “electrode”) includes the electrode material for a lithium-ion secondary battery of the present embodiment. In more detail, the electrode of the present embodiment includes a current collector made of a metal foil and an electrode mixture layer formed on the current collector, and the electrode mixture layer includes the electrode material for a lithium-ion secondary battery of the present embodiment. That is, the electrode of the present embodiment is obtained by forming an electrode mixture layer on one main surface of the current collector using the electrode material for a lithium-ion secondary battery of the present embodiment.

The electrode of the present embodiment is mainly used as cathode for a lithium-ion secondary batteries.

Since the electrode for a lithium-ion secondary battery of the present embodiment includes the electrode material for a lithium-ion secondary battery of the present embodiment, it is possible to provide lithium-ion secondary batteries having high output characteristics and high durability.

Method for Manufacturing Electrode for Lithium-Ion Secondary Battery

A method for manufacturing an electrode of the present embodiment is not particularly limited as long as the electrode mixture layer can be formed on one main surface of the current collector using the electrode material for a lithium-ion secondary battery of the present embodiment. Examples of the method for manufacturing an electrode of the present embodiment include the following method.

First, the electrode material for a lithium-ion secondary battery of the present embodiment, a binding agent made of a binder resin, and a solvent are mixed together, thereby preparing electrode material paste. At this time, to the electrode material paste in the present embodiment, a conductive auxiliary agent such as carbon black may be added if necessary.

Binding Agent

As the binding agent, that is, the binder resin, for example, at least one selected from the group consisting of polytetrafluoroethylene (PTFE) resins, polyvinylidene fluoride (PVdF) resins, fluorine rubber, and the like is preferably used.

The amount of the binding agent blended into the electrode material for a lithium-ion secondary battery of the present embodiment is not particularly limited, and is, for example, preferably 1 part by mass or more and 30 parts by mass or less and more preferably 3 parts by mass or more and 20 parts by mass or less with respect to 100 parts by mass of the electrode material.

When the amount of the binding agent blended is 1 part by mass or more, it is possible to sufficiently increase the binding property between the electrode mixture layer and the current collector. Therefore, it is possible to prevent the electrode mixture layer from being cracked or dropped during the formation of the electrode mixture layer by means of rolling or the like. In addition, it is possible to prevent the electrode mixture layer from being peeled off from the current collector in a process of charging and discharging lithium-ion secondary batteries and prevent the battery capacity or the charge-discharge rate from being decreased. On the other hand, when the amount of the binding agent blended is 30 parts by mass or less, it is possible to prevent the internal resistance of the electrode material for a lithium-ion secondary battery from being decreased and prevent the battery capacity at a high-speed charge and discharge rate from being decreased.

Conductive Auxiliary Agent

The conductive auxiliary agent is not particularly limited, and, for example, at least one selected from the group consisting of fibrous carbon such as acetylene black (AB), Ketjenblack, furnace black, vapor-grown carbon fiber (VGCF), and carbon nanotube is preferably used.

Solvent

The solvent that is used in the electrode material paste including the electrode material for a lithium-ion secondary battery of the present embodiment is appropriately selected depending on the properties of the binding agent. When the solvent is appropriately selected, it is possible to facilitate the electrode material paste to be applied to substances to be coated such as current collectors.

Examples of the solvent include water, alcohols such as methanol, ethanol, 1-propanol, 2-propanol (isopropyl alcohol: IPA), butanol, pentanol, hexanol, octanol, and diacetone alcohol, esters such as ethyl acetate, butyl acetate, ethyl lactate, propylene glycol monomethyl ether acetate, propylene glycol monoethyl ether acetate, and γ-butyrolactone, ethers such as diethyl ether, ethylene glycol monomethyl ether (methyl cellosolve), ethylene glycol monoethyl ether (ethyl cellosolve), ethylene glycol monobutyl ether (butyl cellosolve), diethylene glycol monomethyl ether, and diethylene glycol monoethyl ether, ketones such as acetone, methyl ethyl ketone (MEK), methyl isobutyl ketone (MIBK), acetylacetone, and cyclohexanone, amides such as dimethyl formamide, N,N-dimethylacetoacetamide, and N-methyl-2-pyrrolidone (NMP), glycols such as ethylene glycol, diethylene glycol, and propylene glycol, and the like. These solvents may be used singly, or a mixture of two or more solvents may be used.

The content rate of the solvent in the electrode material paste is preferably 50% by mass or more and 70% by mass or less and more preferably 55% by mass or more and 65% by mass or less in a case in which the total mass of the electrode material for a lithium-ion secondary battery of the present embodiment, the binding agent, and the solvent is set to 100% by mass.

When the content rate of the solvent in the electrode material paste is in the above-described range, it is possible to obtain electrode material paste having excellent electrode formability and excellent battery characteristics.

A method for mixing the electrode material for a lithium-ion secondary battery of the present embodiment, the binding agent, the conductive auxiliary agent, and the solvent is not particularly limited as long as these components can be uniformly mixed together. Examples thereof include mixing methods in which a kneader such as a ball mill, a sand mill, a planetary (sun-and-planet) mixer, a paint shaker, or a homogenizer is used.

The electrode material paste is applied to one main surface of the current collector so as to form a coated film, and then this coated film is dried, thereby obtaining the current collector having a coated film made of a mixture of the electrode material and the binding agent formed on one main surface.

After that, the coated film is pressed by pressure and is dried, thereby producing an electrode having an electrode mixture layer on one main surface of the current collector.

Lithium-Ion Secondary Battery

A lithium-ion secondary battery of the present embodiment includes a cathode, an anode, and a non-aqueous electrolyte, in which the cathode is the electrode for a lithium-ion secondary battery of the present invention. Specifically, the lithium-ion secondary battery of the present embodiment includes the electrode for a lithium-ion secondary battery of the present embodiment as a cathode, an anode, a separator, and a non-aqueous electrolyte.

In the lithium-ion secondary battery of the present embodiment, the anode, the non-aqueous electrolyte, and the separator are not particularly limited.

Anode

Examples of the anode include anodes including an anode material such as Li metal, carbon materials, Li alloys, and Li₄Ti₅O₁₂.

Non-Aqueous Electrolyte

Examples of the non-aqueous electrolyte include non-aqueous electrolytes obtained by mixing ethylene carbonate (EC) and ethyl methyl carbonate (EMC) so that the volume ratio reaches 1:1 and dissolving lithium hexafluorophosphate (LiPF₆) in the obtained solvent mixture so that the concentration reaches 1 mol/dm³.

Separator

As the separator, it is possible to use, for example, porous propylene.

In addition, instead of the non-aqueous electrolyte and the separator, a solid electrolyte may be used.

The lithium-ion secondary battery of the present embodiment includes the electrode for a lithium-ion secondary battery of the present embodiment as the cathode and thus has a high capacity and is highly durable.

### EXAMPLES

Hereinafter, the present invention will be more specifically described using examples and comparative examples, but the present invention is not limited to the following examples.

### Example 1

Synthesis of Electrode Material for Lithium-Ion Secondary Battery

Lithium phosphate (Li₃PO₄) (1,000 mol) and iron (II) sulfate (FeSO₄) (1,000 mol) were added to and mixed with water so that the total amount reached 1,000 L, thereby preparing a homogeneous slurry-form mixture.

Next, this mixture was stored in a pressure-resistant airtight container having a capacity of 2,000 L and was hydrothermally synthesized at 180° C. for one hour, thereby generating a precipitate.

Next, the precipitate was washed with water, thereby obtaining a cake-form precursor of an electrode active material.

Next, lactose (0.25 kg) as the organic compound and zirconia balls having a diameter of 1 mm as medium particles were mixed with this precursor of the electrode active material (5 kg in terms of solid contents), and a dispersion treatment was performed in a ball mill for one hour, thereby preparing a homogeneous slurry.

Next, the slurry was sprayed in the atmosphere at 180° C. and dried, thereby obtaining a granulated body of the electrode active material coated with the organic compound having an average particle diameter of 6 μm.

The water content was adjusted so that the loss on heating measured using a halogen moisture meter in a case in which water was sprayed on the obtained granulated body and the granulated body was heated at 120° C. for one hour reached 1.5% by mass, thereby obtaining a raw material for calcination.

As a continuous calcination furnace for the calcination of the raw material for calcination, a furnace in which resistance heating and electromagnetic wave heating were jointly used, the temperature could be independently controlled in each zone, and an electromagnetic wave-generating device for electromagnetic wave heating which generated electromagnetic waves having an wavelength of 1.0 mm was provided in each temperature zone was used.

The raw material for calcination (5 kg) was fed into a graphite calcination casing having a capacity of 10 L, the calcination casing storing this raw material for calcination was injected into the continuous calcination furnace, the raw material for calcination was calcinated in a non-oxidative gas atmosphere controlled to 760° C. for one hour by means of resistance heating and electromagnetic wave heating and then was held at 40° C. for 30 minutes, thereby obtaining an electrode material of Example 1.

Meanwhile, the temperature of the non-oxidative gas atmosphere is the calcination temperature of the raw material for calcination.

Production of Lithium-Ion Secondary Battery

The electrode material, polyvinylidene fluoride (PVdF) as a binding agent, and acetylene black (AB) as a conductive auxiliary agent were added to N-methyl-2-pyrrolidone (NMP) which was a solvent so that the mass ratio (the electrode material:AB:PVdF) in paste reached 90:5:5, and the components were mixed together, thereby preparing electrode material paste (for the cathode).

Next, the electrode material paste (for the cathode) was applied onto the surface of a 30 μm-thick aluminum foil (current collector) so as to form a coated film, and the coated film was dried, thereby forming a cathode mixture layer on the surface of the aluminum foil.

After that, the cathode mixture layer was pressed by a predetermined pressure so as to obtain a predetermined density, thereby producing a cathode of Example 1.

Next, a disc-shape piece having a diameter of 16 mm was obtained from the cathode using a forming machine by means of punching and was dried in a vacuum, and then a lithium-ion secondary battery of Example 1 was produced using a stainless steel 2032 coin-type cell in a dried argon atmosphere.

As the anode, lithium metal was used, as the separator, a porous polypropylene film was used, and as the electrolytic solution (non-aqueous electrolyte), 1 M of a LiPF₆ solution was used. As the LiPF₆ solution, a solution obtained by mixing ethylene carbonate and ethyl methyl carbonate so that the volume ratio reached 1:1 was used.

### Example 2

An electrode material of Example 2 was obtained in the same manner as in Example 1 except for the fact that the wavelength of electromagnetic waves in the electromagnetic wave-generating device for electromagnetic wave heating was set to 1.2×10 mm.

In addition, a lithium-ion secondary battery of Example 2 was produced in the same manner as in Example 1 except for the fact that the electrode material of Example 2 was used.

### Example 3

An electrode material of Example 3 was obtained in the same manner as in Example 1 except for the fact that the wavelength of electromagnetic waves in the electromagnetic wave-generating device for electromagnetic wave heating was set to 1.2×10² mm.

In addition, a lithium-ion secondary battery of Example 3 was produced in the same manner as in Example 1 except for the fact that the electrode material of Example 3 was used.

### Example 4

An electrode material of Example 4 was obtained in the same manner as in Example 1 except for the fact that the wavelength of electromagnetic waves in the electromagnetic wave-generating device for electromagnetic wave heating was set to 1.0×10⁵ mm.

In addition, a lithium-ion secondary battery of Example 4 was produced in the same manner as in Example 1 except for the fact that the electrode material of Example 4 was used.

### Example 5

An electrode material of Example 5 was obtained in the same manner as in Example 1 except for the fact that the wavelength of electromagnetic waves in the electromagnetic wave-generating device for electromagnetic wave heating was set to 1.0×10⁸ mm.

In addition, a lithium-ion secondary battery of Example 5 was produced in the same manner as in Example 1 except for the fact that the electrode material of Example 5 was used.

### Example 6

Synthesis of Electrode Material for Lithium-Ion Secondary Battery

Lithium phosphate (Li₃PO₄) (1,000 mol) and iron (II) sulfate (FeSO₄) (1,000 mol) were added to and mixed with water so that the total amount reached 1,000 L, thereby preparing a homogeneous slurry-form mixture.

Next, this mixture was stored in a pressure-resistant airtight container having a capacity of 2,000 L and was hydrothermally synthesized at 180° C. for one hour, thereby generating a precipitate.

Next, the precipitate was washed with water, thereby obtaining a cake-form precursor of an electrode active material.

Next, polyvinyl alcohol (0.183 kg) as the organic compound and zirconia balls having a diameter of 1 mm as medium particles were mixed with this precursor of the electrode active material (5 kg in terms of solid contents), and a dispersion treatment was performed in a ball mill for one hour, thereby preparing a homogeneous slurry.

Next, the slurry was sprayed in the atmosphere at 180° C. and dried, thereby obtaining a granulated body of the electrode active material coated with the organic compound having an average particle diameter of 6 μm.

The water content was adjusted so that the loss on heating measured using a halogen moisture meter in a case in which water was sprayed on the obtained granulated body and the granulated body was heated at 120° C. for one hour reached 0.1% by mass, thereby obtaining a raw material for calcination.

As a continuous calcination furnace for the calcination of the raw material for calcination, a furnace in which resistance heating and electromagnetic wave heating were jointly used, the temperature could be independently controlled in each zone, and an electromagnetic wave-generating device for electromagnetic wave heating which generated electromagnetic waves having an wavelength of 1.2×10² mm was provided in each temperature zone was used.

The raw material for calcination (5 kg) was fed into a graphite calcination casing having a capacity of 10 L, the calcination casing storing this raw material for calcination was injected into the continuous calcination furnace, the raw material for calcination was calcinated in a non-oxidative gas atmosphere controlled to 790° C. for one hour by means of resistance heating and electromagnetic wave heating and then was held at 40° C. for 30 minutes, thereby obtaining an electrode material of Example 6.

Production of Lithium-Ion Secondary Battery

The electrode material, polyvinylidene fluoride (PVdF) as a binding agent, and acetylene black (AB) as a conductive auxiliary agent were added to N-methyl-2-pyrrolidone (NMP) which was a solvent so that the mass ratio (the electrode material:AB:PVdF) in paste reached 90:5:5, and the components were mixed together, thereby preparing electrode material paste (for the cathode).

Next, the electrode material paste (for the cathode) was applied onto the surface of a 30 μm-thick aluminum foil (current collector) so as to form a coated film, and the coated film was dried, thereby forming a cathode mixture layer on the surface of the aluminum foil.

After that, the cathode mixture layer was pressed by a predetermined pressure so as to obtain a predetermined density, thereby producing a cathode of Example 6.

Next, a disc-shape piece having a diameter of 16 mm was obtained from the cathode using a forming machine by means of punching and was dried in a vacuum, and then a lithium-ion secondary battery of Example 6 was produced using a stainless steel (SUS) 2032 coin-type cell in a dried argon atmosphere.

As the anode, lithium metal was used, as the separator, a porous polypropylene film was used, and as the electrolytic solution (non-aqueous electrolyte), 1 M of a LiPF₆ solution was used. As the LiPF₆ solution, a solution obtained by mixing ethylene carbonate and ethyl methyl carbonate so that the volume ratio reached 1:1 was used.

### Example 7

An electrode material of Example 7 was obtained in the same manner as in Example 6 except for the fact that a raw material for calcination in which the water content was adjusted so that the loss on heating measured using a halogen moisture meter in a case in which the granulated body was heated at 120° C. for one hour reached 1.0% by mass was used.

In addition, a lithium-ion secondary battery of Example 7 was produced in the same manner as in Example 6 except for the fact that the electrode material of Example 7 was used.

### Example 8

An electrode material of Example 8 was obtained in the same manner as in Example 6 except for the fact that a raw material for calcination in which the water content was adjusted so that the loss on heating measured using a halogen moisture meter in a case in which the granulated body was heated at 120° C. for one hour reached 3.0% by mass was used.

In addition, a lithium-ion secondary battery of Example 8 was produced in the same manner as in Example 6 except for the fact that the electrode material of Example 8 was used.

### Example 9

An electrode material of Example 9 was obtained in the same manner as in Example 6 except for the fact that a raw material for calcination in which the water content was adjusted so that the loss on heating measured using a halogen moisture meter in a case in which the granulated body was heated at 120° C. for one hour reached 10.0% by mass was used.

In addition, a lithium-ion secondary battery of Example 9 was produced in the same manner as in Example 6 except for the fact that the electrode material of Example 9 was used.

### Example 10

Synthesis of Electrode Material for Lithium-Ion Secondary Battery

Lithium phosphate (Li₃PO₄) (1,000 mol) andiron (II) sulfate (FeSO₄) (1,000 mol) were added to and mixed with water so that the total amount reached 1,000 L, thereby preparing a homogeneous slurry-form mixture.

Next, this mixture was stored in a pressure-resistant airtight container having a capacity of 2,000 L and was hydrothermally synthesized at 180° C. for one hour, thereby generating a precipitate.

Next, the precipitate was washed with water, thereby obtaining a cake-form precursor of an electrode active material.

Next, polyethylene glycol (0.183 kg) as the organic compound and zirconia balls having a diameter of 1 mm as medium particles were mixed with this precursor of the electrode active material (5 kg in terms of solid contents), and a dispersion treatment was performed in a ball mill for one hour, thereby preparing a homogeneous slurry.

Next, the slurry was sprayed in the atmosphere at 180° C. and dried, thereby obtaining a granulated body of the electrode active material coated with the organic compound having an average particle diameter of 6 μm.

The water content was adjusted so that the loss on heating measured using a halogen moisture meter in a case in which water was sprayed on the obtained granulated body and the granulated body was heated at 120° C. for one hour reached 1.5% by mass, thereby obtaining a raw material for calcination.

As a continuous calcination furnace for the calcination of the raw material for calcination, a furnace in which resistance heating and electromagnetic wave heating were jointly used, the temperature could be independently controlled in each zone, and an electromagnetic wave-generating device for electromagnetic wave heating which generated electromagnetic waves having an wavelength of 1.2×10² mm was provided in each temperature zone was used.

The raw material for calcination (5 kg) was fed into a graphite calcination casing having a capacity of 10 L, the calcination casing storing this raw material for calcination was injected into the continuous calcination furnace, the raw material for calcination was calcinated in a non-oxidative gas atmosphere controlled to 730° C. for one hour by means of resistance heating and electromagnetic wave heating and then was held at 40° C. for 30 minutes, thereby obtaining an electrode material of Example 10.

Production of Lithium-Ion Secondary Battery

The electrode material, polyvinylidene fluoride (PVdF) as a binding agent, and acetylene black (AB) as a conductive auxiliary agent were added to N-methyl-2-pyrrolidone (NMP) which was a solvent so that the mass ratio (the electrode material:AB:PVdF) in paste reached 90:5:5, and the components were mixed together, thereby preparing electrode material paste (for the cathode).

Next, the electrode material paste (for the cathode) was applied onto the surface of a 30 μm-thick aluminum foil (current collector) so as to form a coated film, and the coated film was dried, thereby forming a cathode mixture layer on the surface of the aluminum foil.

After that, the cathode mixture layer was pressed by a predetermined pressure so as to obtain a predetermined density, thereby producing a cathode of Example 10.

Next, a disc-shape piece having a diameter of 16 mm was obtained from the cathode using a forming machine by means of punching and was dried in a vacuum, and then a lithium-ion secondary battery of Example 10 was produced using a stainless steel 2032 coin-type cell in a dried argon atmosphere.

As the anode, lithium metal was used, as the separator, a porous polypropylene film was used, and as the electrolytic solution (non-aqueous electrolyte), 1M of a LiPF₆ solution was used. As the LiPF₆ solution, a solution obtained by mixing ethylene carbonate and ethyl methyl carbonate so that the volume ratio reached 1:1 was used.

### Example 11

An electrode material of Example 11 was obtained in the same manner as in Example 10 except for the fact that the temperature of the non-oxidative gas atmosphere was set to 800° C.

In addition, a lithium-ion secondary battery of Example 11 was produced in the same manner as in Example 10 except for the fact that the electrode material of Example 11 was used.

### Comparative Example 1

Synthesis of Electrode Material for Lithium-Ion Secondary Battery

Lithium phosphate (Li₃PO₄) (1,000 mol) and iron (II) sulfate (FeSO₄) (1,000 mol) were added to and mixed with water so that the total amount reached 1,000 L, thereby preparing a homogeneous slurry-form mixture.

Next, this mixture was stored in a pressure-resistant airtight container having a capacity of 2,000 L and was hydrothermally synthesized at 180° C. for one hour, thereby generating a precipitate.

Next, the precipitate was washed with water, thereby obtaining a cake-form precursor of an electrode active material.

Next, polyvinyl alcohol (0.183 kg) as the organic compound and zirconia balls having a diameter of 1 mm as medium particles were mixed with this precursor of the electrode active material (5 kg in terms of solid contents), and a dispersion treatment was performed in a ball mill for one hour, thereby preparing a homogeneous slurry.

Next, the slurry was sprayed in the atmosphere at 180° C. and dried, thereby obtaining a granulated body of the electrode active material coated with the organic compound having an average particle diameter of 6 μm.

The water content was adjusted so that the loss on heating measured using a halogen moisture meter in a case in which water was sprayed on the obtained granulated body and the granulated body was heated at 120° C. for one hour reached 1.5% by mass, thereby obtaining a raw material for calcination.

As a continuous calcination furnace for the calcination of the raw material for calcination, a resistance heating-type electric furnace in which the temperature could be independently controlled in each zone was used.

The raw material for calcination (5 kg) was fed into a graphite calcination casing having a capacity of 10 L, the calcination casing storing this raw material for calcination was injected into the continuous calcination furnace, the raw material for calcination was calcinated in a non-oxidative gas atmosphere controlled to 800° C. for one hour by means of resistance heating and electromagnetic wave heating and then was held at 40° C. for 30 minutes, thereby obtaining an electrode material of Comparative Example 1.

Production of Lithium-Ion Secondary Battery

A lithium-ion secondary battery of Comparative Example 1 was produced in the same manner as in Example 1 except for the fact that the electrode material of Comparative Example 1 was used.

### Comparative Example 2

An electrode material of Comparative Example 2 was obtained in the same manner as in Comparative Example 1 except for the fact that the temperature of the non-oxidative gas atmosphere was set to 760° C.

In addition, a lithium-ion secondary battery of Comparative Example 2 was produced in the same manner as in Comparative Example 1 except for the fact that the electrode material of Comparative Example 2 was used.

### Comparative Example 3

An electrode material of Comparative Example 3 was obtained in the same manner as in Comparative Example 1 except for the fact that the temperature of the non-oxidative gas atmosphere was set to 730° C.

In addition, a lithium-ion secondary battery of Comparative Example 3 was produced in the same manner as in Comparative Example 1 except for the fact that the electrode material of Comparative Example 3 was used.

### Comparative Example 4

Synthesis of Electrode Material for Lithium-Ion Secondary Battery

Lithium phosphate (Li₃PO₄) (1,000 mol) and iron (II) sulfate (FeSO₄) (1,000 mol) were added to and mixed with water so that the total amount reached 1,000 L, thereby preparing a homogeneous slurry-form mixture.

Next, this mixture was stored in a pressure-resistant airtight container having a capacity of 2,000 L and was hydrothermally synthesized at 180° C. for one hour, thereby generating a precipitate.

Next, the precipitate was washed with water, thereby obtaining a cake-form precursor of an electrode active material.

Next, lactose (0.25 kg) as the organic compound and zirconia balls having a diameter of 1 mm as medium particles were mixed with this precursor of the electrode active material (5 kg in terms of solid contents), and a dispersion treatment was performed in a ball mill for one hour, thereby preparing a homogeneous slurry.

Next, the slurry was sprayed in the atmosphere at 180° C. and dried, thereby obtaining a granulated body of the electrode active material coated with the organic compound having an average particle diameter of 6 μm.

The water content was adjusted so that the loss on heating measured using a halogen moisture meter in a case in which water was sprayed on the obtained granulated body and the granulated body was heated at 120° C. for one hour reached 1.5% by mass, thereby obtaining a raw material for calcination.

As a continuous calcination furnace for the calcination of the raw material for calcination, a furnace in which resistance heating and electromagnetic wave heating were jointly used, the temperature could be independently controlled in each zone, and an electromagnetic wave-generating device for electromagnetic wave heating which generated electromagnetic waves having an wavelength of 1.0×10⁻¹ mm was provided in each temperature zone was used.

The raw material for calcination (5 kg) was fed into a graphite calcination casing having a capacity of 10 L, the calcination casing storing this raw material for calcination was injected into the continuous calcination furnace, the raw material for calcination was calcinated in a non-oxidative gas atmosphere controlled to 760° C. for one hour by means of resistance heating and electromagnetic wave heating and then was held at 40° C. for 30 minutes, thereby obtaining an electrode material of Comparative Example 4.

Production of Lithium-Ion Secondary Battery

The electrode material, polyvinylidene fluoride (PVdF) as a binding agent, and acetylene black (AB) as a conductive auxiliary agent were added to N-methyl-2-pyrrolidone (NMP) which was a solvent so that the mass ratio (the electrode material:AB:PVdF) in paste reached 90:5:5, and the components were mixed together, thereby preparing electrode material paste (for the cathode).

Next, the electrode material paste (for the cathode) was applied onto the surface of a 30 μm-thick aluminum foil (current collector) so as to form a coated film, and the coated film was dried, thereby forming a cathode mixture layer on the surface of the aluminum foil.

After that, the cathode mixture layer was pressed by a predetermined pressure so as to obtain a predetermined density, thereby producing a cathode of Comparative Example 4.

Next, a disc-shape piece having a diameter of 16 mm was obtained from the cathode using a forming machine by means of punching and was dried in a vacuum, and then a lithium-ion secondary battery of Comparative Example 4 was produced using a stainless steel 2032 coin-type cell in a dried argon atmosphere.

As the anode, lithium metal was used, as the separator, a porous polypropylene film was used, and as the electrolytic solution (non-aqueous electrolyte), 1 M of a LiPF₆ solution was used. As the LiPF₆ solution, a solution obtained by mixing ethylene carbonate and ethyl methyl carbonate so that the volume ratio reached 1:1 was used.

### Comparative Example 5

An electrode material of Comparative Example 5 was obtained in the same manner as in Comparative Example 4 except for the fact that the wavelength of electromagnetic waves in the electromagnetic wave-generating device for electromagnetic wave heating was set to 5.0×10⁸ mm.

In addition, a lithium-ion secondary battery of Comparative Example 5 was produced in the same manner as in Comparative Example 4 except for the fact that the electrode material of Comparative Example 5 was used.

### Comparative Example 6

An electrode material of Comparative Example 6 was obtained in the same manner as in Comparative Example 4 except for the fact that the amount of lactose as the organic compound added was set to 0.025 kg, and the wavelength of electromagnetic waves in the electromagnetic wave-generating device for electromagnetic wave heating was set to 1.2×10² mm.

In addition, a lithium-ion secondary battery of Comparative Example 6 was produced in the same manner as in Comparative Example 4 except for the fact that the electrode material of Comparative Example 6 was used.

Evaluation of Electrode Materials for Lithium-Ion Secondary Battery

On the electrode materials for a lithium-ion secondary battery of Examples 1 to 11 and Comparative Examples 1 to 6, the following evaluation was performed.

(1) Powder Resistance

The electrode material was injected into a mold and was compressed at a pressure of 45 MPa, and the powder resistance of the electrode material was measured by means of four-point measurement using a low resistivity meter (model No.: Loresta-GP, manufactured by Mitsubishi Chemical Analytech Co., Ltd.) at 25° C.

Evaluation of Lithium-Ion Secondary Batteries

On the lithium-ion secondary batteries of Examples 1 to 11 and Comparative Examples 1 to 6, the following evaluation was performed.
(1) Trickle Test Irreversible Capacity

A lithium-ion secondary battery including an anode formed of lithium metal was constant current charged at an environmental temperature of 60° C. and a current value of 0.1 C until the battery voltage reached 4.2 V and then was constant voltage charged for ten days. After that, the battery was constant current discharged at a current value of 0.1 C until the battery voltage reached 2 V. The difference between the sum of the constant current charge capacity and the constant voltage charge capacity and the constant current discharge capacity was considered as the trickle test irreversible capacity (mAh/g).

(2) 5 C/0.1 C Discharge Capacity Ratio

A lithium-ion secondary battery including an anode formed of lithium metal was constant current charged at an environmental temperature of 25° C. and a current value of 0.1 C until the battery voltage reached 4.2 V and then was constant voltage charged, and the charging was ended when the current value reached 0.01 C. After that, the battery was discharged at a discharge current of 0.1 C, and the discharge was ended when the battery voltage reached 2 V. The discharge capacity at this time was measured and was considered as the 0.1 C discharge capacity.

Next, the lithium-ion secondary battery was constant current charged at a current value of 1 C until the battery voltage reached 4.2 V and then was constant voltage charged, and the charging was ended when the current value reached 0.1 C. After that, the battery was discharged at a discharge current of 5 C, and the discharge was ended when the battery voltage reached 2 V. The discharge capacity at this time was measured and was considered as the 5 C discharge capacity. A value obtained by dividing the 5 C discharge capacity by the 0.1 C discharge capacity was considered as the 5 C/0.1 C discharge capacity ratio.

(3) 500-Cycle Discharge Capacity Retention

A lithium-ion secondary battery including an anode made of natural graphite was constant current charged at an environmental temperature of 60° C. and a current value of 2 C until the battery voltage reached 4.2 V and then was constant voltage charged, and the charging was ended when the current value reached 0.01 C. After that, the battery was discharged at a discharge current of 2 C, and the discharge was ended when the battery voltage reached 2 V. The discharge capacity at this time was measured and was considered as the initial capacity.

After that, charge and discharge were repeated under the above-described conditions, the discharge capacity at the 500th cycle was measured, and the discharge capacity retention (%) with respect to the initial capacity was computed.

Evaluation Results

The evaluation results of the electrode materials for a lithium-ion secondary battery of Examples 1 to 11 and the lithium-ion secondary batteries of Examples 1 to 11 are shown in Table 1, and the evaluation results of the electrode materials for a lithium-ion secondary battery of Comparative Examples 1 to 6 and the lithium-ion secondary batteries of Comparative Examples 1 to 6 are shown in Table 2.

TABLE 1

| | | | Amount | | | | | | |
|---|---|---|---|---|---|---|---|---|---|
| | | Loss on | of | | | Trikle test | 0.1 C | 5 C/0.1 C | 500-Cycle |
| | Wavelength of | heating | carbon | Calcination | Powder | irreversible | discharge | discharge | capacity |
| | electromagnetic | [% by | [% by | temperature | resistance | capacity | capacity | capacity | retention |
| | waves [mm] | mass] | mass] | [° C.] | [Ω · cm] | [mAh/g] | [mAh/g] | ratio | [%] |
| Example 1 | 1.0 | 1.5 | 1.0 | 760 | 130 | 18 | 160 | 0.80 | 70 |
| Example 2 | 1.2 × 10 | 1.5 | 1.1 | 760 | 112 | 16 | 160 | 0.81 | 72 |
| Example 3 | 1.2 × 10² | 1.5 | 1.3 | 760 | 79 | 16 | 160 | 0.83 | 73 |
| Example 4 | 1.0 × 10⁵ | 1.5 | 1.1 | 760 | 114 | 16 | 160 | 0.81 | 71 |
| Example 5 | 1.0 × 10⁸ | 1.5 | 1.1 | 760 | 120 | 15 | 160 | 0.81 | 71 |
| Example 6 | 1.2 × 10² | 0.1 | 1.2 | 790 | 12 | 19 | 160 | 0.83 | 72 |
| Example 7 | 1.2 × 10² | 1.0 | 1.3 | 790 | 10 | 15 | 160 | 0.85 | 71 |
| Example 8 | 1.2 × 10² | 3.0 | 1.3 | 790 | 8 | 17 | 160 | 0.82 | 73 |
| Example 9 | 1.2 × 10² | 10.0 | 1.2 | 790 | 8 | 17 | 160 | 0.83 | 75 |
| Example | 1.2 × 10² | 1.5 | 1.3 | 730 | 85 | 19 | 158 | 0.82 | 72 |
| 10 | | | | | | | | | |
| Example | 1.2 × 10² | 1.5 | 0.9 | 800 | 5 | 20 | 160 | 0.91 | 70 |
| 11 | | | | | | | | | |

TABLE 2

| | | | Amount | | | | | | |
|---|---|---|---|---|---|---|---|---|---|
| | | Loss on | of | | | Trikle test | 0.1 C | 5 C/0.1 C | 500-Cycle |
| | Wavelength of | heating | carbon | Calcination | Powder | irreversible | discharge | discharge | capacity |
| | electromagnetic | [% by | [% by | temperature | resistance | capacity | capacity | capacity | retention |
| | waves [mm] | mass] | mass] | [° C.] | [Ω · cm] | [mAh/g] | [mAh/g] | ratio | [%] |
| Comparative | — | 1.5 | 0.8 | 800 | 8 | 65 | 160 | 0.89 | 54 |
| Example 1 | | | | | | | | | |
| Comparative | — | 1.5 | 0.9 | 760 | 161 | 19 | 160 | 0.78 | 71 |
| Example 2 | | | | | | | | | |
| Comparative | — | 1.5 | 0.9 | 730 | 287 | 18 | 160 | 0.76 | 69 |
| Example 3 | | | | | | | | | |
| Comparative | 1.0 × 10⁻¹ | 1.5 | 1.2 | 760 | 151 | 21 | 160 | 0.77 | 70 |
| Example 4 | | | | | | | | | |
| Comparative | 5.0 × 10⁸ | 1.5 | 1.3 | 760 | 138 | 21 | 160 | 0.78 | 71 |
| Example 5 | | | | | | | | | |
| Comparative | 1.2 × 10² | 1.5 | 0.08 | 760 | 100000 | 88 | 127 | 0.45 | 49 |
| Example 6 | | | | | | | | | |

When Examples 1 to 11 and Comparative Examples 1 to 6 were compared with each other using the results in Tables 1 and 2, in the electrode materials for a lithium-ion secondary battery of Examples 1 to 11, the powder resistance under compression at a pressure of 45 MPa was 130 Ω·cm or lower, and, in the lithium-ion secondary batteries of Examples 1 to 11, the trickle test irreversible capacity was 20 mAh/g or less. As described above, it could be confirmed that the electrode materials for a lithium-ion secondary battery of Examples 1 to 11 and lithium-ion secondary batteries including a cathode including the same electrode material exhibit favorable battery characteristics.

### INDUSTRIAL APPLICABILITY

According to the method for manufacturing an electrode material for a lithium-ion secondary battery of the present invention, it is possible to decrease the temperature unevenness in calcination casings and sufficiently carbonize organic compounds which are raw materials of carbonaceous films. Therefore, it is possible to decrease the content of low-valence iron-based impurities in the electrode material for a lithium-ion secondary battery of the present invention. Lithium-ion secondary batteries including an electrode for a lithium-ion secondary battery produced using the electrode material for a lithium-ion secondary battery of the present invention as a cathode are excellent in terms of output characteristics and durability or stability. These lithium-ion secondary batteries have a high discharge capacity and a high energy density and thus can be applied to next-generation secondary batteries that are anticipated to have a higher voltage, a higher energy density, higher load characteristics, and high-speed charging characteristics. In this case, the effects of the present invention become extremely significant.

What is claimed is:

1. An electrode material for a lithium-ion secondary battery comprising:
an electrode active material; and
a carbonaceous film with which a surface of the electrode active material is coated,
wherein a powder resistance under compression at a pressure of 45 MPa is 130 Ω·cm or lower, and
battery characteristics that a difference between a sum of a charge capacity of a lithium-ion secondary battery including a cathode including the electrode material for a lithium-ion secondary battery and an anode made of lithium metal obtained when constant current charged with an upper limit voltage with respect to the anode set to 4.20 V and a charge capacity of the lithium-ion secondary battery obtained when constant voltage charged at 4.20 V for ten days after the constant current charge and a discharge capacity of the lithium-ion secondary battery obtained when constant current discharged to 2 V after the constant voltage charge is set to 20 mAh/g or lower are exhibited.

2. The electrode material for a lithium-ion secondary battery according to claim 1,
wherein the electrode active material includes as a main component one selected from the group consisting of lithium cobalt oxide, lithium nickel oxide, lithium manganese oxide, lithium titanium oxide, and compounds represented by LiₓA_{y}D_{z}PO₄ (here, A represents at least one selected from the group consisting of Co, Mn, Ni, Fe, Cu, and Cr, D represents at least one selected from the group consisting of Mg, Ca, Sr, Ba, Ti, Zn, B, Al, Ga, In, Si, Ge, Sc, Y, and rare earth elements, 0≦x<2, 0<y<1.5, and 0≦z<1.5).

3. An electrode for a lithium-ion secondary battery comprising:
the electrode material for a lithium-ion secondary battery according to claim 1.

4. A lithium-ion secondary battery comprising:
a cathode;
an anode; and
a non-aqueous electrolyte,
wherein the cathode is the electrode for a lithium-ion secondary battery according to claim 3.

5. A method for manufacturing an electrode material for a lithium-ion secondary battery including an electrode active material and a carbonaceous film with which a surface of the electrode active material is coated, comprising:
a slurry preparation step of preparing a slurry by mixing at least one electrode active material particle raw material selected from the group consisting of the electrode active material and precursors of the electrode active material, an organic compound which is a precursor of the carbonaceous film, and a solvent together;
and a calcination step of drying the slurry and calcinating the obtained dried substance in a non-oxidative atmosphere by means of both resistance heating and electromagnetic wave heating.

6. The method for manufacturing an electrode material for a lithium-ion secondary battery according to claim 5,
wherein the electrode active material which is coated with the organic compound or a precursor of the electrode active material contains moisture, and, in a case in which the electrode active material or the precursor of the electrode active material is heated at 100° C. to 200° C. for 0.5 hours to 1.0 hour, a loss on heating measured using a halogen moisture meter is 0.1% by mass or more and less than 10% by mass.

7. The method for manufacturing an electrode material for a lithium-ion secondary battery according to claim 5,
wherein, in the electromagnetic wave heating, electromagnetic waves having a wavelength of 1 mm or longer and 100 km or shorter are used.
